(19) United States
(12) Patent Application Publication
(10) Pub. No.: US 2005/0243098 A1
(43) Pub. Date: Nov. 3, 2005

(54) Photo movie producing method and apparatus

(75) Inventors: Koichi Gohara, Kanagawa (JP); Hiroshi Murakami, Kanagawa (JP); Kei Yamaji, Kanagawa (JP); Hajime Araya, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/106,727

(22) Filed: Apr. 15, 2005

(30) Foreign Application Priority Data
Apr. 15, 2004 (JP) 2004-120441

(51) Int. Cl. G09G 5/00

(52) U.S. Cl. 345/581; 345/613

(57) ABSTRACT

In a photo movie producing apparatus, a scenario producing section includes a parameter normalizing circuit which normalizes a parameter in a scenario into a format based on a predetermined pixel number not dependent on a pixel number of still images to be inputted in an image editor and an edited image. The image editor handles the still images and the edited image within a virtual pixel space by using the normalized parameter. In a preferred embodiment, each still image is normalized to a pixel number in accordance with an output format of a photo movie, before the image editing.

### BACKGROUND OF THE INVENTION

1. Field of the Invention

The present invention relates to a method and an apparatus for producing a photo movie in which still images are edited like a movie.

2. Description of the Related Art

A photo movie, as disclosed in U.S. Patent Application Publication No. 2002/0110354, is an image sequence produced by modifying still images on the basis of a scenario and editing the still images into a form just like a moving picture. In a photo movie producing apparatus, a user, on the basis of a scenario produced in accordance with the purpose of production, carries out selection of an image and various types of graphically modifying processing of the image such as transformation (enlargement, reduction, rotation, and the like), zooming, masking (cropping and synthesis), moving, combining sequences, and the like. The photo movie obtained thereby can be enjoyed by viewing on a monitor of a photo movie outputting apparatus. In addition, the photo movie obtained thereby can be enjoyed also by recording on recording media such as a DVD (Digital Versatile Disk) and the like, and by printing out frames of the photo movie by a printer.

However, the still images which are the base of the photo movie do not always have the same pixel number. Likewise, in addition, the maximum representable pixel numbers on destinations (a monitor, DVD, printer, and the like) of the photo movie are often not the same as one another. Thus, the handling of data in editing (modifying and combining) images become very complicated and the processing time for editing becomes very long. Further, according to the circumstances, because processing such as transformation and zooming, which entail reduction of the image quality, should be repeatedly performed, there is the possibility of causing reduction of the image quality of the photo movie.

### SUMMARY OF THE INVENTION

In view of the foregoing, a primary object of the present invention is to provide a method and an apparatus for producing a photo movie capable of shortening the processing time for editing an image.

Another object of the present invention is to provide a method and an apparatus for producing a photo movie capable of preventing reduction of the image quality of a photo movie.

In order to achieve the above and other objects, the present invention, in producing a scenario, normalizes a parameter included in the scenario and used for image editing into a format based on a predetermined pixel number. In image editing, a still image and an edited image are handled within a common virtual pixel space by using the normalized parameter.

In a preferred embodiment of the present invention, each still image is normalized to a pixel number in accordance with the output format of the photo movie, before being edited.

According to the method and the apparatus for producing the photo movie of the present invention, the parameter in the scenario is normalized into the format based on a predetermined pixel number not dependent on the pixel number of the still image and the modified image. Therefore, it is possible to easily handle data and to shorten the processing time for editing the image. In addition, because the processing of transformation and zooming, which entail reduction of the image quality, can be performed at once, it is possible to prevent reduction of the image quality of the photo movie. In addition, image modification becomes easier because the still image which is not yet modified is normalized to a pixel number in accordance with the output format of the photo movie.

### BRIEF DESCRIPTION OF THE DRAWINGS

The above objects and advantages of the present invention will become apparent to a person skilled in the art from the following detailed description of the preferred embodiments of the invention when read in conjunction with the accompanying drawings, in which:

FIG. 1 is a block diagram showing an outline constitution of a photo movie producing apparatus to which the present invention is applied;

FIG. 2 is an explanatory view showing a format of a scenario;

FIG. 3 is a block diagram showing an internal construction of an image editor; and

FIG. 4 is a flow chart showing the steps of producing a photo movie.

### DETAILED DESCRIPTION OF THE PREFERRED EMBODIMENT(S)

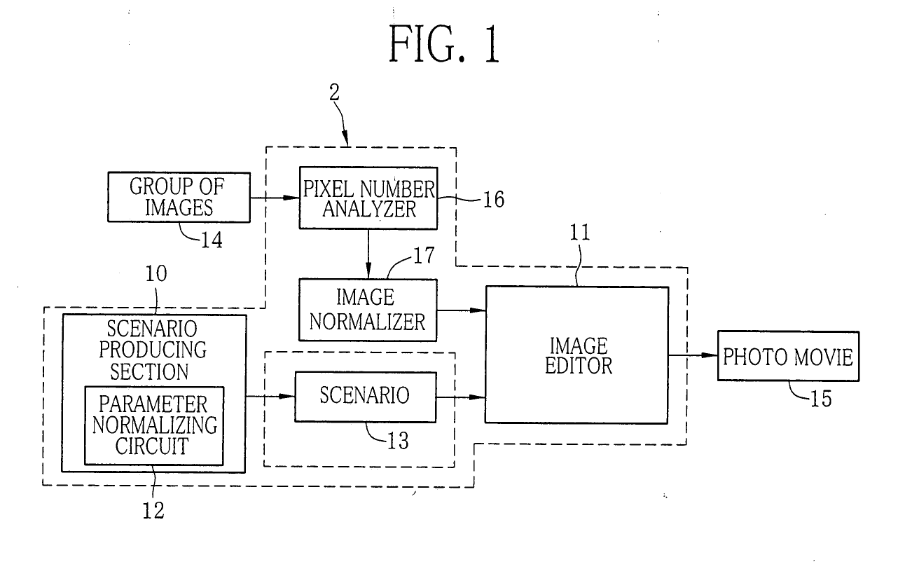

In FIG. 1, a photo movie producing apparatus 2 of the present invention includes a scenario producing section 10 and an image editor 11, and the like. The scenario producing section 10 includes a parameter normalizing circuit 12 and normalizes a parameter of an original scenario to produce an execution scenario or script (hereinafter referred to as a “scenario”) 13 determining a form of representing an image. The scenario 13 produced in the scenario producing section 10 is inputted to the image editor 11 together with a group of images 14 which includes still images (hereinafter referred to as an “image”). The image editor 11 edits (graphically modifies and combines) images in accordance with the scenario 13 and outputs a photo movie 15 or image sequence produced by the editing. The images of the group of images 14 include digital images obtained by photoelectrically reading the images recorded on imaging devices such as a digital camera, a cell-phone with camera, and the like, a photographic film, and a photographic paper, as well as template images used for synthesis of a background image or a mask image of the photo movie 15.

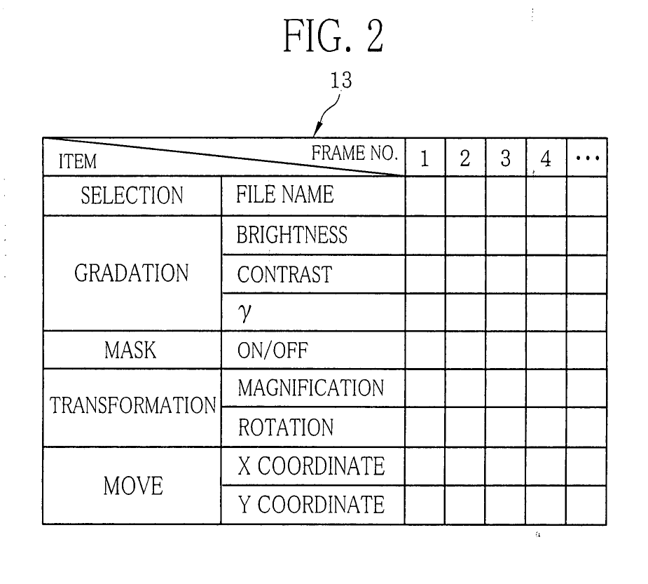

As shown in FIG. 2, the scenario 13 has a format in which a file name, a gradation correction value (brightness, contrast, and y-correction value), presence or absence of masking, and various parameters such as a transformation parameter (ratio of enlargement and reduction, and rotation) and a moving parameter (X and Y coordinates) of the image selected from among the group of images 14 in order to produce the photo movie 15 are designated per each frame of the photo movie 15. The frame rate of the photo movie 15 is set at, for example, 60 frames per second.

In FIG. 1, the parameter normalizing circuit 12 normalizes the various parameters handled in the scenario 13 into a format based on a predetermined pixel number not dependent on the pixel number of the image and the photo movie (for example, 4,096×4,096 (vertical and horizontal) pixels). Thereby in the image editor 11, the inputted image and the edited image are handled within a virtual pixel space of the same pixel number.

A pixel number analyzer 16 analyzes the pixel number of each image in the group of images 14 and transmits a result of the analysis to an image normalizer 17. The image normalizer 17, on the basis of the result of analysis transmitted from the pixel number analyzer 16, normalizes the pixel number of each image in the group of images 14 to the pixel number in accordance with an output format of the photo movie 15. That is, for example, in the case where the output format of the photo movie 15 is VGA (Video Graphics Array) size, the image normalizer 17 performs normalization so that the pixel number may be 720 (vertical)×640 (horizontal) pixels.

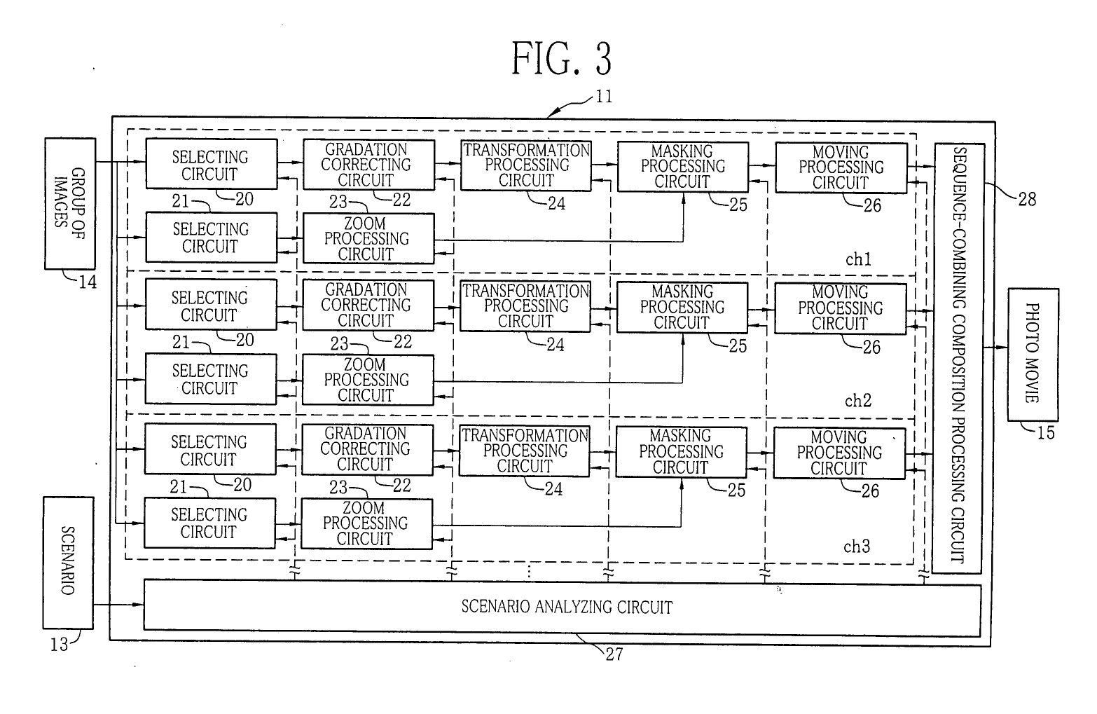

As shown in FIG. 3, the image editor 11 is provided with a plurality of processing channels Chn (n=1, 2, 3 . . . ), which includes selecting circuits 20 and 21, a gradation correcting circuit 22, a zoom processing circuit 23, a transformation processing circuit 24, a masking processing circuit 25, and a moving processing circuit 26, and the image editor 11 is also provided with a scenario analyzing circuit 27 and a sequence-combining composition processing circuit 28.

The processing channel Chn forms frames constituting the photo movie 15 one by one. For example, the processing channel Chn produces one scene of the photo movie 15 (containing several seconds with a section determined by a changeover of one image to another or a section determined between the beginning and ending of a certain special effect) with a plurality of the processing channels Chn sharing the performance of processing.

The selecting circuits 20 and 21 select the image with the file name designated by the scenario 13 and the template image respectively from the group of images 14. The gradation correcting circuit 22, on the basis of the gradation correction value described in the scenario 13, performs gradation correction to the image selected by the selecting circuit 20. To give a specific example, a special effect processing such as turning a color image into a black-and-white image or into a sepia-tone image is performed so that the image may look like an old picture.

The zoom processing circuit 23 performs zoom processing to the template image selected by the selecting circuit 21. The transformation processing circuit 24, on the basis of transformation parameters described in the scenario 13, performs transformation processing to the image. To give a specific example, the special effect processing is performed by enlarging and reducing a certain part of the image as if zooming operation were performed.

The masking processing circuit 25 performs synthesis for a masking processing to the image and the template image. To give a specific example, the masking processing circuit 25 performs a processing such as cropping one part of the image and pasting such part on the template image in which specific patterns and characters are described. The moving processing circuit 26 performs a moving processing to the image on the basis of the moving parameter described in the scenario 13. To give a specific example, the special effect processing is performed as if panning operation were performed, assuming the image to be one frame.

Here, in the selecting circuit 20, the gradation correcting circuit 22, and the transformation processing circuit 24, the processing is performed in accordance with the pixel number of the inputted image. In the selecting circuit 21 and the zoom processing circuit 23, the processing is performed in accordance with the pixel number of the inputted template image. In the zoom processing circuit 23, the transformation processing circuit 24, the masking processing circuit 25, and the moving processing circuit 26, the processing is performed in accordance with the pixel number of the edited image. In the zoom processing circuit 23 and the transformation processing circuit 24, two pixel numbers, namely, the pixel number of the template image and the photo movie 15 and the pixel number of the image and the photo movie 15, are mixed, however, because these are handled within the virtual pixel space and are actually normalized to the predetermined pixel number by the image normalizer 17, it is possible to perform the zoom and transformation processing at once.

The scenario analyzing circuit 27 analyzes the inputted scenario 13 and denormalizes various parameters of the scenario 13 to the pixel number of the inputted image and the edited image, and then supplies the various parameters to each circuit 20 to 26 in the processing channel Chn. Each circuit 20 to 26 performs various types of processing on the basis of the various parameters supplied from the scenario analyzing circuit 27. On the other hand, when there are no parameters designated by the scenario 13, each circuit 20 to 26 does not perform processing and transfers the image to the subsequent circuit.

The composition processing circuit 28 combines the frames formed by each processing channel Chn in chronological order on the basis of a time stamp provided when the scenario 13 is produced, and produces the photo movie 15.

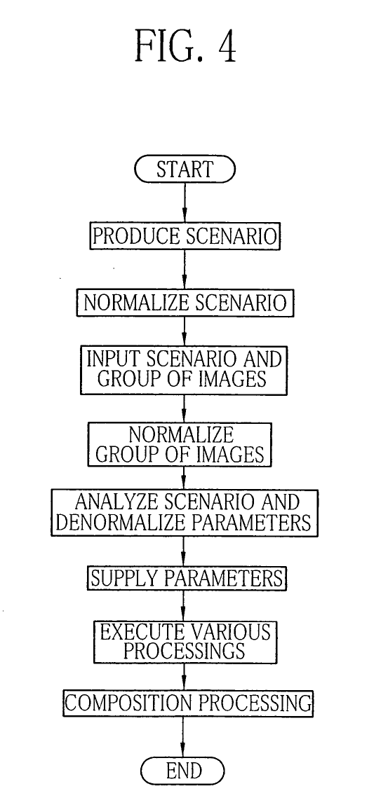

Next, the operation according to the above constitution will be explained referring to the flow chart of FIG. 4. First, in the scenario producing section 10, the scenario 13 for producing the photo movie 15 or image sequence is produced. At this time, the various parameters of the scenario 13 are normalized into a format based on the predetermined pixel number not dependent on the pixel number of the image and the photo movie 15. In addition, each image in the group of images 14 is, after the pixel number of each of the plurality of images is analyzed by the pixel number analyzer 16, normalized to the pixel number in accordance with the output format of the photo movie 15 by the image normalizer 17.

The produced scenario 13 is inputted to the image editor 11 together with the group of images 14 normalized by the image normalizer 17. In the image editor 11, the scenario 13 is analyzed by the scenario analyzing circuit 27 and the various parameters of the scenario 13 are denormalized to the pixel number of the inputted image and the edited image.

The various denormalized parameters are supplied to each circuit 20 to 26 in the processing channel Chn. In each circuit 20 to 26, various types of processing are performed on the basis of the various parameters supplied from the scenario analyzing circuit 27.

In the composition processing circuit 28 for combining sequences, the frames formed by each processing channel Chn are combined in chronological order on the basis of the time stamp provided when the scenario 13 is produced, and the photo movie 15 is produced. The produced photo movie 15 is displayed on a monitor or recorded on a DVD by a DVD recorder, or one specified frame of the produced photo movie 15 is printed out by a printer.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A method of producing a photo movie comprising the steps of:
producing a scenario determining a form of graphically representing an image;
editing each of plural still images in accordance with said produced scenario; and
outputting said photo movie produced by said editing, wherein
a parameter included in said scenario and used for image editing is normalized into a format based on a predetermined pixel number not dependent on a pixel number of said still images and said edited image.

2. A method of producing a photo movie as recited in claim 1, wherein in said image editing, said still images and said edited image are handled within a virtual pixel space by using said normalized parameter.

3. A method of producing a photo movie as recited in claim 2, further comprising the step of:
normalizing said still images to a pixel number in accordance with an output format of said photo movie, before said editing.

4. A method of producing a photo movie as recited in claim 3, wherein said editing includes at least one of gradation correction, transformation processing, masking processing, and moving processing.

5. A method of producing a photo movie comprising the steps of:
producing a scenario determining a form of graphically representing an image;
normalizing plural still images to a pixel number in accordance with an output format of said photo movie;
editing each of said still images in accordance with said scenario; and
outputting said photo movie produced by said editing.

6. An apparatus for producing a photo movie comprising:
a scenario producing section for producing a scenario determining a form of graphically representing an image, said scenario producing section normalizing a parameter included in said scenario and used for said editing into a format based on a predetermined pixel number; and
an image editor for producing said photo movie by editing each of still images in accordance with said produced scenario.

7. An apparatus for producing a photo movie as recited in claim 6, wherein said image editor handles said still images and said edited image within a virtual pixel space by using said normalized parameter.

8. An apparatus for producing a photo movie as recited in claim 7, further comprising:
an image normalizer for normalizing each of said still images to a pixel number in accordance with an output format of said photo movie, before said image editing.

9. An apparatus for producing a photo movie comprising:
a scenario producing section for producing a scenario determining a form of graphically representing an image;
an image normalizer for normalizing each of still images to a pixel number in accordance with an output format of said photo movie; and
an image editor for editing each of said still images in accordance with said scenario to produce said photo movie.
